(19) United States
(12) Patent Application Publication
(10) Pub. No.: US 2007/0054624 A1
(43) Pub. Date: Mar. 8, 2007

(54) Broadcasting base station device, mobile terminal device, hierarchical modulation setup method, broadcast system, and hierarchical modulation setup computer program

(75) Inventor: Hiroki Kashiwagi, Chiba-Shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha, Osaka-shi (JP)

(21) Appl. No.: 11/233,071

(22) Filed: Sep. 23, 2005

(30) Foreign Application Priority Data
Sep. 7, 2005 (JP) 2005-259941

(51) Int. Cl. H04B 17/00

(52) U.S. Cl. 455/67.13

(57) ABSTRACT

A broadcasting base station device transmits broadcast signals modulated by a hierarchical modulation scheme to a mobile terminal device. A hierarchical modulation setup section compares the reception quality of the broadcast signals at the location of the mobile terminal device to predetermined reference quality. Based on the result of the comparison, the hierarchical modulation setup section specifies a hierarchical modulation scheme. For example, the constellation in each quadrant is reduced or enlarged. Accordingly, the broadcasting base station device can transmit optimal broadcast signals that match with actual reception quality to each mobile terminal device.

This Nonprovisional application claims priority under 35 U.S.C. § 119(a) on Patent Application No. 2005-259941 filed in Japan on Sep. 7, 2005, the entire contents of which are hereby incorporated by reference.

### FIELD OF THE INVENTION

The present invention relates to broadcasting base station devices for broadcasting a broadcast program modulated by hierarchical modulation and also to hierarchical modulation setup methods by which the broadcasting base station devices are set up for hierarchical modulation. The invention relates further to hierarchical modulation setup computer programs realizing the broadcasting base station device on a computer and to mobile terminal devices which measures the reception quality of incoming broadcast signals to inform the broadcasting base station device. The invention relates also to broadcast systems including the broadcasting base station device and the mobile terminal devices.

### BACKGROUND OF THE INVENTION

Recent years have witnessed increasingly active movement toward merger and integration of communications and broadcasting. An example of actual development or proposal is mobile phones that incorporate an analog or digital broadcast receiver (tuner) to receive program broadcasts. This trend of broadcasting being integrated into mobile communications will likely to continue in the coming era.

In the field of mobile communications, broadcast-type services are already implemented whereby one base station delivers the same information to multiple terminal station devices. These services are however not very popular yet, due to limited transmission capacity, expensive packet transmission fees, and the poor quality and low quantity of provided content in view of the fees.

Another emerging phenomenon is the accelerating growth of bandwidth in wireless communications just as in wired communications. The growth is attracting attention for its potential capability to handle video and other large amount of data, which is expected to open new opportunities in broadcast-type communications service. For example, in 3GPP (3rd Generation Partnership Project), the standardization of MBMS (Multimedia Broadcast/Multicast Service), a broadcast-type communications standard, is in progress.

Japanese Unexamined Patent Publication 2004-40661 (Tokukai 2004-40661; published on Jul. 8, 2004) discloses technology related to this standard. The base station device disclosed in Tokukai 2004-40661 performs hierarchical modulation on a broadcast program by using differences in error rate between individual modulation symbol points. The document also discloses a wireless communications mobile station device which receives hierarchical data transmitted from a base station device. The mobile station device feeds back the reception quality of the received broadcast program to the base station device.

Japanese Unexamined Patent Publication 10-32557/1998 (Tokukaihei 10-32557; published on Feb. 3, 1998) discloses a hierarchical modulation method involving a constellation of symbol points which are separated from each other by different distances. This method allows for hierarchical modulation of data for an increased number of levels.

Here is a list of patent documents disclosing hierarchical modulation: Japanese Unexamined Patent Publication 11-88287/1999 (Tokukaihei 11-88287; published on Mar. 30, 1999); Japanese Unexamined Patent Publication 11-98104/1999 (Tokukaihei 11-98104; published on Sep. 5, 1999); Japanese Unexamined Patent Publication 2000-31944 (Tokukai 2000-31944; published on Jan. 28, 2000); Japanese Unexamined Patent Publication 2000-68959 (Tokukai 2000-68959; published on Mar. 3, 2000); Japanese Unexamined Patent Publication 2004-40661 (Tokukai 2004-40661; published on Feb. 5, 2004); and Japanese Unexamined Patent Publication 2004-128988 (Tokukai 2004-128988; published on Apr. 22, 2004).

Hierarchical modulation technology has been used in satellite broadcast and communications between stationary stations, for example. Using hierarchical modulation, abrupt deterioration of the reception state due to heavy rain and other factors can be alleviated provided that the reception is stable to a certain level under normal conditions. Meanwhile, in broadcast-type, general mobile communications, the number of communication terminal stations a base station can handle which are in the service area and capable of receiving broadcast signals provides an important index for base station performance evaluation. Typically, traffic on a broadcast signal varies from one base station to another. The environments in which the broadcast signal propagates are also different: e.g., the size and shape of the service area and the geography and architectural structures in the service area. Further, the locations of the terminal devices in the service area change greatly with time.

The base station therefore cannot flexibly deal with environmental changes around it through simple hierarchical modulation and power control.

If adjacent base stations transmit the same data on the same channel, no particular problems occur. However, if they do so on different channels, and one of the base stations increases its transmission power, the broadcast signal will cause an increased level of interference on the other, adjacent base station.

Considering these problems, there exist some unavoidable restrictions in the installation of base stations.

A constellation for hierarchical modulation must be decided for each base station to be installed. The decision requires a lot of time and labor due to large numbers of restrictions involved. Even after the installation is completed, the environments around the base stations can change greatly. For example, after the installation of the base stations, high-rise buildings may be built or a hill be leveled in the service area. These environmental changes naturally cause changes in propagation environment for broadcast signals. As a result, a weak signal (poor reception area) can occur where it is not expected.

If we are slow to identify propagation environment changes, we cannot take action on time. Were the changes spotted quickly, the strength of the broadcast signals would have to be measured again to decide a new hierarchical modulation scheme for the service area. In either case, conventional technology does not provide optimal and flexible solutions that suit ever-changing propagation environment.

### SUMMARY OF THE INVENTION

The present invention, conceived to address these problems, has an objective to provide a broadcasting base station device, hierarchical modulation setup method, mobile terminal device, broadcast system, and hierarchical modulation setup computer program that send broadcast signals optimized in view of actual reception quality to mobile terminal devices.

To solve the problems, a broadcasting base station device in accordance with the present invention is characterized as follows. The broadcasting base station device transmits to a mobile terminal device a broadcast signal modulated by a hierarchical modulation scheme whereby multiple hierarchical data streams are allocated respectively to multiple bits of a multilevel-modulation symbol. The station device includes: reception quality comparing means for comparing reception quality of the broadcast signal at a location of the mobile terminal device to predetermined reference quality; and hierarchical modulation setup means for specifying a difference in error rate in bit determination between the multiple different bits on the basis of a result of the comparison by the reception quality comparing means.

According to the arrangement, the broadcasting base station device transmits to a mobile terminal device a broadcast signal generated by the hierarchical modulation of a broadcast program. For example, the data stream of the broadcast program is hierarchically split into the first, basic data stream and its supplementary part, or the second data stream. The hierarchical data stream is modulated by, for example, a common 16QAM mode or a nonuniform constellation 16QAM mode. In 16QAM, each symbol assumes 16 states. In other words, 16QAM is a multilevel modulation scheme where each symbol represents 4 bits. It is however known that error rate in bit determination differs slightly between 2 of the 4 bits and the remaining 2 bits. In the nonuniform constellation 16QAM, the difference in error rate becomes naturally notable. Under these conditions where there is a difference in error rate in bit determination between bits of one symbol in this manner, the first data stream is allocated to the 2 bits with a lower error rate, and the second data stream is allocated to the 2 bits with a higher error rate.

In other words, a minimally required data stream for the demodulation of the broadcast data is allocated to the first 2 bits of each symbol point with a lower error rate. Further, a supplementary data stream required to obtain broadcast data with relatively high quality is allocated to the last 2 bits of each symbol point with a higher error rate. The mobile terminal device receives the broadcast signals hierarchically modulated in this manner and demodulate the broadcast program. Since the broadcast data is hierarchically modulated, the mobile terminal device demodulates both the upper and lower data streams under good broadcast signal propagation conditions to obtain the broadcast program with relatively high quality. In contrast, under poor propagation conditions, the mobile terminal device can still obtain the broadcast program with low, but acceptable quality by demodulating the two data streams.

This is achieved by the mobile terminal device by the use of a certain means which measures the reception quality of the received broadcast signal. For example, the reception quality of the broadcast signal is measured through the measurement of the signal strength of the broadcast signal upon reception. Further, the mobile terminal device notifies the broadcasting base station device of the measured reception quality together with the information on the location of the mobile terminal device over the predetermined communications network. Accordingly, the broadcasting base station device obtains the reception quality as measured by the mobile terminal device and the location where the measurement was made.

In the broadcasting base station device, the reception quality comparing means compares the reception quality as forwarded from the mobile terminal device to predetermined reference quality. The reference quality is, for example, contained in advance in predetermined memory in the broadcasting base station device. By comparing the reception quality at the location of the mobile terminal device to the predetermined reference quality, for example, the reception quality comparing means decides which quality is better.

Based on the result of the comparison by the reception quality comparing means, the hierarchical modulation setup means decides on a hierarchical modulation scheme for the modulation of broadcast signals. For example, if the reception quality at the location of the mobile terminal device is determined to be lower (poorer) than the predetermined reference quality, the hierarchical modulation setup means changes the difference in error rate between bits to an increased value. The change increases the error rate for the bits for which the error rate was originally high. On the other hand, the change decreases the error rate for the bits for which the error rate was originally low. Therefore, the change improves the error rate in the bit determination for the first data stream, enabling the broadcast signals to reach mobile terminal devices located further from the broadcasting base station device. That is, the service area of the broadcasting base station device can be expanded. The hierarchical modulation setup means should specify the difference in error rate so that the reception quality at the location of the mobile terminal device which has forwarded the reception quality is not below the reference quality.

In addition, if the reception quality at the location of the mobile terminal device is determined to be higher (better) than the reference quality, the hierarchical modulation setup means changes the difference in error rate in bit determination to a decreased value. The change decreases the error rate for the bits for which the error rate was originally high. On the other hand, the change increases the error rate for the bits for which the error rate was originally low. Therefore, the change improves the error rate in the bit determination as to the supplementary data stream, thereby improving on the reception quality of the broadcast program as received by the mobile terminal device in view of the quality prior to the change to the difference in error rate.

In this manner, the broadcasting base station device arranged as above flexibly alters hierarchical modulation schemes for use in broadcast signal modulation in accordance with whether the reception quality of the broadcast program at the location of the mobile terminal device receiving the broadcast signals is good or poor. Accordingly, the broadcasting base station device can transmit to the mobile terminal devices optimal broadcast signals in accordance with the actual reception quality.

To solve the problems, a hierarchical modulation setup method in accordance with the present invention is characterized as follows. The hierarchical modulation setup method sets up a broadcasting base station device for a hierarchical modulation scheme whereby multiple hierarchical data streams are allocated respectively to multiple bits of a multilevel-modulation symbol. The broadcasting base station device modulates a broadcast signal by the hierarchical modulation scheme for transmission to a mobile terminal device. The method includes the steps of: (a) comparing the reception quality of the broadcast signal as received by the mobile terminal device to predetermined reference quality; and (b) specifying a difference in error rate in bit determination between the multiple different bits on the basis of a result of the comparison in step (a).

The arrangement achieves the same effects as the broadcasting base station device above.

To solve the problems, a mobile terminal device in accordance with the present invention is characterized as follows. The mobile terminal device notifies the foregoing broadcasting base station device of the reception quality of the received broadcast signal. The mobile terminal device includes reception quality notifying means for notifying the broadcasting base station device of the reception quality only when the mobile terminal device is located at a predetermined location.

According to the arrangement, the reception quality notifying means notifies the broadcasting base station device of the reception quality only when the mobile terminal device is located at a predetermined location. That particular location is, for example, on the perimeter of the service area coverage by the broadcasting base station device. In other words, the reception quality notifying means notifies the broadcasting base station device of the reception quality only when particular conditions are met: i.e., only when the mobile terminal device is at the particular location. The mobile terminal device avoids to unconditionally notify the broadcasting base station device of the reception quality. Accordingly, the mobile terminal device can decrease the amount of information processed in notifying the broadcasting base station device of the reception quality.

To solve the problems, another mobile terminal device in accordance with the present invention is characterized as follows. The mobile terminal device notifies the foregoing broadcasting base station device of the reception quality of the received broadcast signal. The mobile terminal device includes reception quality notifying means for notifying the broadcasting base station device of the reception quality and a location of the mobile terminal device when the reception quality is lower than a predetermined threshold.

According to the arrangement, the reception quality notifying means notifies the broadcasting base station device of the reception quality and the location of the mobile terminal device when the reception quality of the broadcast signal is lower than a predetermined threshold. In other words, if the reception quality is determined to be good, the reception quality notifying means does not notify the broadcasting base station device of the reception quality. Therefore, the mobile terminal device can decrease the amount of information processed in notifying the broadcasting base station device of the reception quality.

To solve the problems, another mobile terminal device in accordance with the present invention is characterized as follows. The mobile terminal device notifies any one of the foregoing broadcasting base station devices of the reception quality of the received broadcast signal. The mobile terminal device includes reception quality notifying means for notifying the broadcasting base station device of the reception quality of the broadcast signal when the mobile terminal device is located at a predetermined location at which the mobile terminal device should notify of the reception quality even if the terminal is not receiving any broadcast programs.

According to the arrangement, the reception quality notifying means notifies the broadcasting base station device of the reception quality of the broadcast signal when the mobile terminal device is located at a predetermined location at which the mobile terminal device should notify of the reception quality even if the terminal is not receiving any broadcast programs. Therefore, the mobile terminal device can reliably notify the broadcasting base station device of the reception quality of the broadcast signal at the predetermined location.

To solve the problems, a broadcast system in accordance with the present invention is characterized as follows. The system includes any one of the foregoing broadcasting base station devices and any one of the foregoing mobile terminal devices.

According to the arrangement, there is provided a broadcast system where the broadcasting base station device can transmit to the mobile terminal devices optimal broadcast signals in accordance with the actual reception quality.

Additional objects, advantages and novel features of the invention will be set forth in part in the description which follows, and in part will become apparent to those skilled in the art upon examination of the following or may be learned by practice of the invention.

### BRIEF DESCRIPTION OF THE DRAWINGS

FIG. 1 is a block diagram illustrating a broadcast system of the present embodiment in detail.

FIG. 2(a) is a constellation diagram showing an example of modulation schemes available for use by the broadcasting base station device 1. The figure shows a BPSK symbol point constellation.

FIG. 2(b) is a constellation diagram showing an example of modulation schemes available for use by the broadcasting base station device 1. The figure shows a QPSK symbol point constellation.

FIG. 2(c) is a constellation diagram showing an example of modulation schemes available for use by the broadcasting base station device 1. The figure shows a 16QAM symbol point constellation.

FIG. 3(a) is a schematic illustrating a mechanism for determining a bit in QPSK. The figure shows a mechanism for determining the first bit b1.

FIG. 3(b) is a schematic illustrating a mechanism for determining a bit in QPSK. The figure shows a mechanism for determining the second bit b2.

FIG. 4(a) is a schematic illustrating a mechanism for determining a bit in a uniform 16QAM constellation. The figure shows a mechanism for determining the first bit b1.

FIG. 4(b) is a schematic illustrating a mechanism for determining a bit in a uniform 16QAM constellation. The figure shows a mechanism for determining the second bit b2.

FIG. 4(c) is a schematic illustrating a mechanism for determining a bit in a uniform 16QAM constellation. The figure shows a mechanism for determining the third bit b3.

FIG. 4(d) is a schematic illustrating a mechanism for determining a bit in a uniform 16QAM constellation. The figure shows a mechanism for determining the fourth bit b4.

FIG. 5(a) is a schematic illustrating a mechanism for determining a bit in a nonuniform 16QAM constellation. The figure shows a mechanism for determining the first bit b1.

FIG. 5(b) is a schematic illustrating a mechanism for determining a bit in a nonuniform 16QAM constellation. The figure shows a mechanism for determining the second bit b2.

FIG. 5(c) is a schematic illustrating a mechanism for determining a bit in a nonuniform 16QAM constellation. The figure shows a mechanism for determining the third bit b3.

FIG. 5(d) is a schematic illustrating a mechanism for determining a bit in a nonuniform 16QAM constellation. The figure shows a mechanism for determining the fourth bit b4.

FIG. 6 is a diagram illustrating a method of altering a constellation which is executed by a hierarchical modulation setup section.

FIG. 7 is a diagram illustrating a method of altering another constellation which is executed by a hierarchical modulation setup section.

FIG. 8 is a flow chart showing a process flow whereby a broadcasting base station device alters hierarchical modulation schemes.

FIG. 9 is a flow chart showing a process flow executed by a broadcasting base station device to monitor the quality of a broadcast signal received by the mobile terminal device.

### DESCRIPTION OF THE EMBODIMENTS

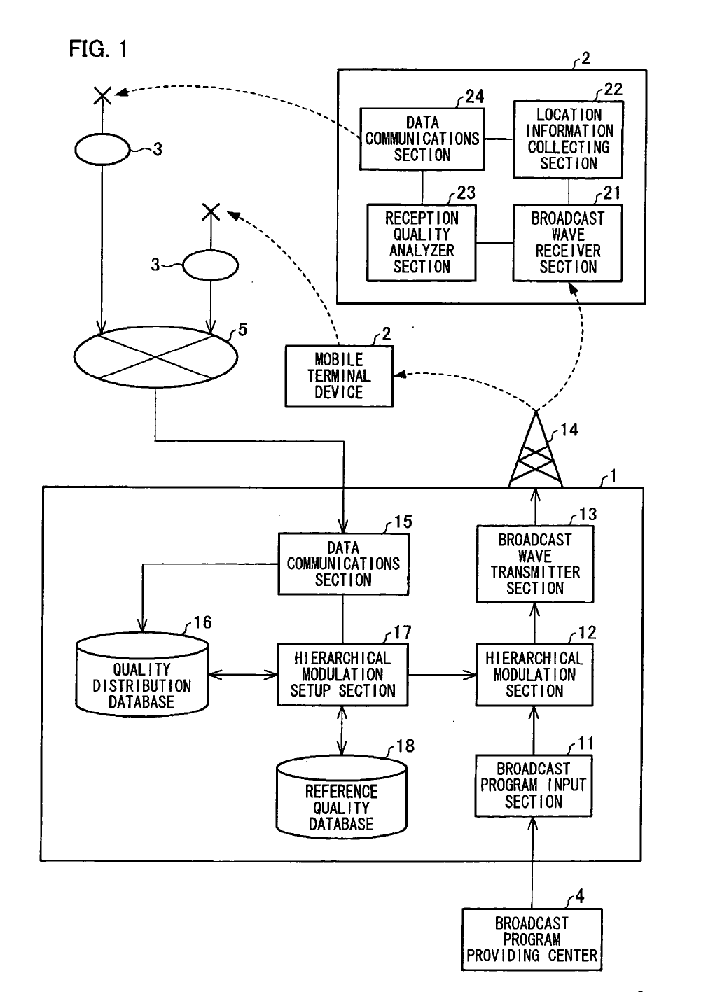

The following will describe an embodiment of the present invention in reference to FIG. 1 to FIG. 9.

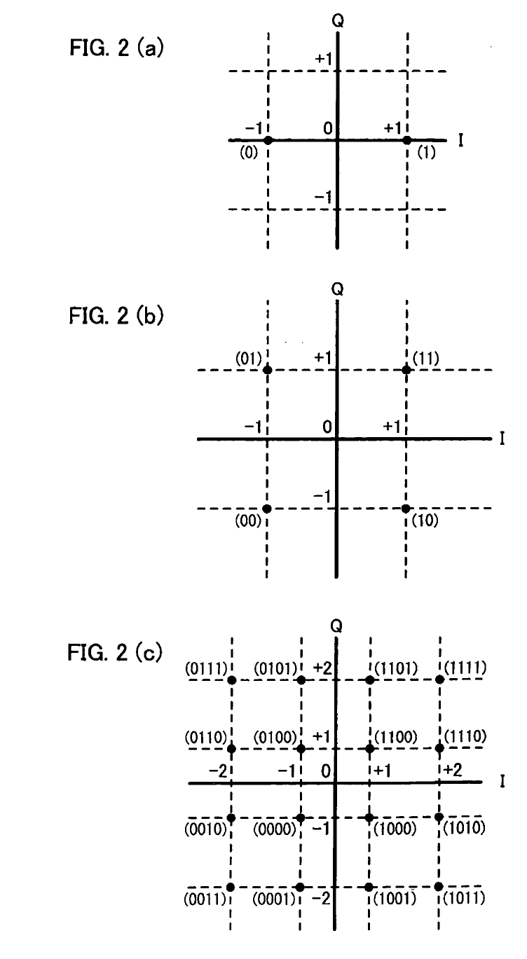

First, referring to FIGS. 2(a) to 2(c), will be explained the modulation available for use by a broadcasting base station device 1. FIG. 2(a) is a constellation diagram showing an example of modulation schemes available for use by the broadcasting base station device 1. The figure shows a BPSK symbol point constellation. FIG. 2(b) is a constellation diagram showing an example of modulation schemes available for use by the broadcasting base station device 1. The figure shows a QPSK symbol point constellation. FIG. 2(c) is a constellation diagram showing an example of modulation schemes available for use by the broadcasting base station device 1. The figure shows a 16QAM symbol point constellation. In these diagrams, the imaginary part of a signal is indicated on the vertical axis (Q-axis), whereas the real part is indicated on the horizontal axis (1-axis).

As shown in FIG. 2(a), in BPSK, there are two symbol points both on the I-axis. This means that the broadcasting base station device 1 allocates 1-bit information to each symbol point. In QPSK, as shown in FIG. 2(b), there are four symbol points in the I-Q plane. This means that the broadcasting base station device 1 allocates 2-bit information to each symbol point. Further, in 16QAM, as shown in FIG. 2(c), there are 16 symbol points in the I-Q plane. This means that the broadcasting base station device 1 allocates 4-bit information to each symbol point.

The broadcasting base station device 1 allocates data so that data differs between any adjacent pair of symbol points in the I-Q plane only by 1 bit. That is, the broadcasting base station device 1 allocates data to the symbol points by gray encoding.

(Determining Bits in QPSK)

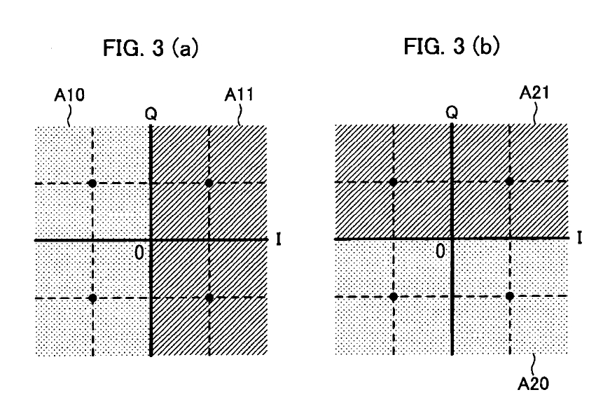

The broadcasting base station device 1 generates broadcast signals by modulating a broadcast program and transmits the waves to a mobile terminal device 2. The broadcast signals are demodulated by the mobile terminal device 2 upon reception. Specifically, the mobile terminal device 2 demodulates the data allocated to the symbol points by a predetermined bit determination. This QPSK bit determination by the mobile terminal device 2 is now described in reference to FIGS. 3(a) and 3(b) which are schematics illustrating a QPSK bit determination mechanism. FIG. 3(a) is one showing a mechanism for determining the first bit b1. FIG. 3(b) is one showing a mechanism for determining the second bit b2. As mentioned earlier, the broadcasting base station device 1 allocates two bits to each symbol point in QPSK. In the following, the first of the two bits of information allocated by the broadcasting base station device 1 to a symbol point is indicated by b1, and the second by b2.

(Determining b1)

As mentioned earlier, in QPSK modulation, the broadcasting base station device 1 allocates two bits to each symbol point. In the following, the first of the two bits of information allocated by the broadcasting base station device 1 to a symbol point is indicated by b1, and the second by b2.

The broadcasting base station device 1 determines the value (either 0 or 1) of each bit of the symbol point, depending on which part of the I-Q plane the point is in. For example, if a symbol point is in the region where I is positive (to the right of the Q-axis), its b1 is “1.” If the symbol point is in the region where I is negative (to the left of the Q-axis), b1 is “0.” Accordingly, if a received symbol is in the positive I region (region All) as shown in FIG. 3(a), the mobile terminal device 2 determines its b1 to be “1.” In contrast, if the received symbol is in the negative I region (region A10), b1 is determined to be “0.”

(Determining b2)

If the symbol point is in the region where Q is positive (above the I-axis), its b2 is “1.” If the symbol point is in the region where Q is negative (below the I-axis), b2 is “0.” Accordingly, if the received symbol is in the positive Q region (region A21) as shown in FIG. 3(b), the mobile terminal device 2 determines its b2 to be “1.” In contrast, if the received symbol is in the negative Q region (region A20), b2 is determined to be “0.”

(Determining Bits in 16QAM)

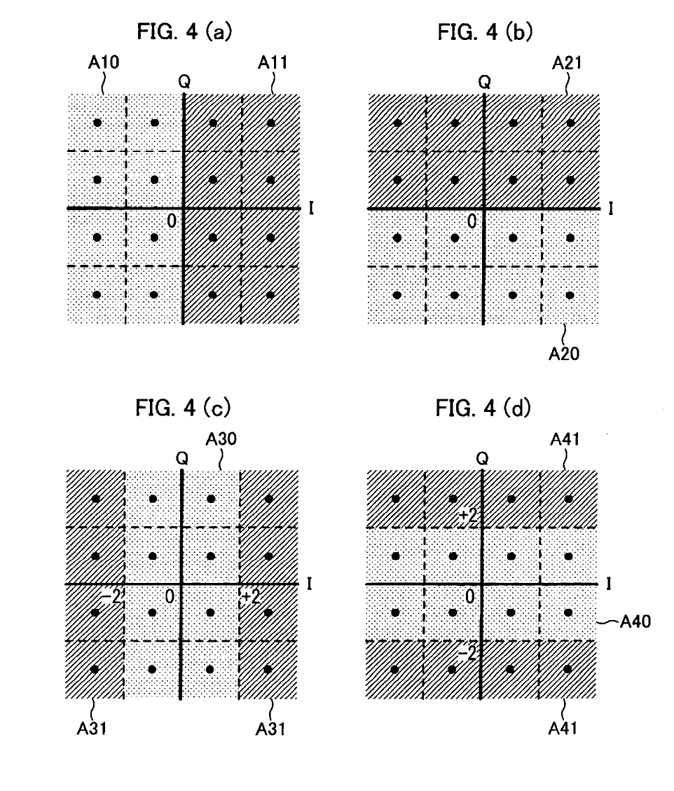

Bit determination in 16QAM is now described in reference to FIGS. 4(a) to 4(d) which are schematics illustrating a bit determination mechanism in a uniform 16QAM constellation. FIG. 4(a) is one showing a mechanism for determining the first bit b1. FIG. 4(b) is one showing a mechanism for determining the second bit b2. FIG. 4(c) is one showing a mechanism for determining the third bit b3. FIG. 4(d) one showing a mechanism for determining the fourth bit b4. As mentioned earlier, the broadcasting base station device 1 allocates four bits to each symbol point in 16QAM. In the following, the first, second, third, and fourth of the four bits of information allocated by the broadcasting base station device 1 to a symbol point is indicated by b1, b2, b3, and b4 respectively.

(Determining b1)

The value (either 0 or 1) of each bit allocated to a symbol point is determined depending on which part of the I-Q plane the point is in. For example, if a symbol point is in the region where I is positive (to the right of the Q-axis), its b1 is “1.” If the symbol point is in the region where I is negative (to the left of the Q-axis), b1 is “0.” Accordingly, if a received symbol is in the positive I region (region All) as shown in FIG. 4(a), the mobile terminal device 2 determines its b1 to be “1.” In contrast, if the received symbol is in the negative I-axis region (region A10), b1 is determined to be “0.”

(Determining b2)

If the symbol point is in the region where Q is positive (above the I-axis), its b2 is “1.” If the symbol point is in the region where Q is negative (below the I-axis), b2 is “0.” Accordingly, if the received symbol is in the positive Q region (region A21) as shown in FIG. 4(b), the mobile terminal device 2 determines its b2 to be “1.” In contrast, if the received symbol is in the negative Q region (region A20), b2 is determined to be “0.”

(Determining b3)

If the symbol point is in the region where I is from −2 to +2, its b3 is “1.” In other words, if the symbol point is in the region flanked by the line passing point +2 on the I-axis and extending parallel to the Q-axis and the line passing point −2 on the I-axis and extending parallel to the Q-axis, b3 is “1.” If the symbol point is either in the region where I is greater than +2 or in the region where I is smaller than −2, its b3 is “0.” In other words, if the symbol point is either in the region to the right of the line passing point +2 on the I-axis and extending parallel to the Q-axis or in the region to the left of the line passing point −2 on the I-axis and extending parallel to the Q-axis, b3 is. “0.” Accordingly, if the received symbol is in region A30 as shown in FIG. 4(c), the mobile terminal device 2 determines its b3 to be “1.” In contrast, if the received symbol is in region A31, b3 is determined to be “0.”

(Determining b4)

If the symbol point is in the region where Q is from −2 to +2, its b4 is “1.” In other words, if the symbol point is in the region flanked by the line passing point +2 on the Q-axis and extending parallel to the I-axis and the line passing point −2 on the Q-axis and extending parallel to the I-axis, b4 is “1.” If the symbol point is either in the region where Q is greater than +2 or in the region where Q is smaller than −2, its b4 is “0.” In other words, if the symbol point is either in the region above the line passing point +2 on the Q-axis extending parallel to the I-axis or in the region below the line passing point −2 on the Q-axis and extending parallel to the I-axis, b4 is “0.” Accordingly, if the received symbol is in region A40 as shown in FIG. 4(d), the mobile terminal device 2 determines its b4 to be “1.” In contrast, if the received symbol is in region A41, b4 is determined to be “0.”

As described in the foregoing, the mobile terminal device 2 can determine the b1 bit by merely discriminating between positive/negative values of the received symbol on the I-axis. Further, it can determine the b2 bit by merely discriminating between positive/negative values of the received symbol on the Q-axis. On the other hand, the b3 bit cannot be determined unless it is determined whether the value of the received symbol on the I-axis is between or beyond the two threshold values. Further, the b4 bit cannot be determined unless it is determined whether the value of the received symbol on the Q-axis is between or beyond the two threshold values. Therefore, error rate is lower in the determination of b1 and b2 than in the determination of b3 and b4. In other words, the error rate in the determination of the received symbol bits varies with the position of the symbol point in the I-Q plane.

(Nonuniform Constellation)

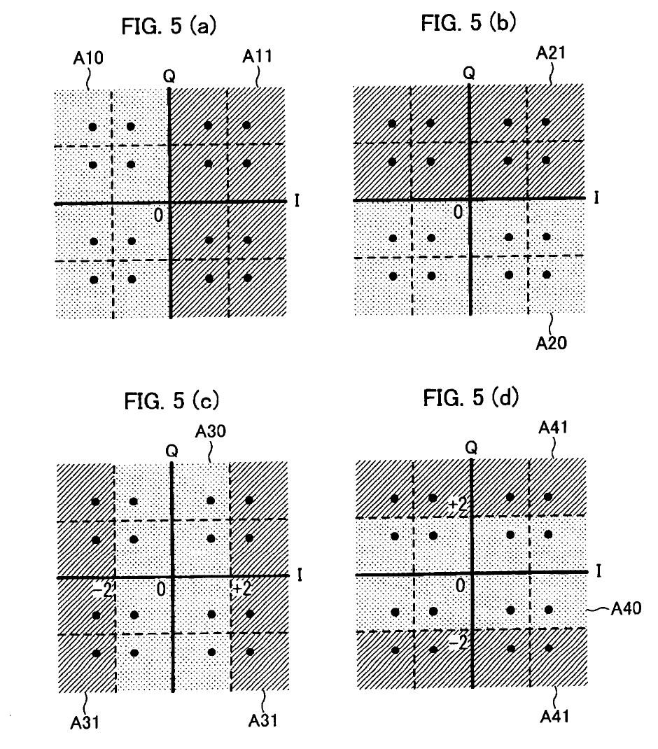

The broadcasting base station device 1 is capable of flexibly changing the error rate in the determination of received symbol bits, by adjusting the distribution of the symbol points in the I-Q plane. An example will be described in the following in reference to FIGS. 5(a) to 5(d) which are schematics illustrating a bit determination mechanism in a nonuniform 16QAM constellation. FIG. 5(a) is one showing a mechanism for determining the first bit b1. FIG. 5(b) is one showing a mechanism for determining the second bit b2. FIG. 5(c) is one showing a mechanism for determining the third bit b3. FIG. 5(d) is one showing a mechanism for determining the fourth bit b4.

Unlike the one in FIGS. 4(a) to 4(d), the constellation in the figure is nonuniform, that is, each symbol point is separated from its adjacent ones by unequal distances. Accordingly, the error rate in the determination of the b1 bit increases when compared with the 16QAM illustrated in FIGS. 4(a) to 4(d). The same applies to the b2 bit. Conversely, the error rate in the determination of the b3 bit decreases when compared with the 16QAM illustrated in FIGS. 4(a) to 4(d). The same applies to the b4 bit.

The error rate in the determination of the bits changes with the distribution of the constellation, that is, sets of symbol points, even if the modulation scheme remains the same (16QAM). The more widely distributed the constellation in the individual quadrant, the higher the error rate for the b1 and b2 bits, and the lower the error rate for the b3 and b4 bits. Conversely, the more tightly squeezed the constellation, the lower the error rate for the b1 and b2 bits, and the higher the error rate for the b3 and b4 bits.

As explained here, 16QAM hierarchical modulation based on a nonuniform constellation provides distinct differences in error rate from one bit to another. Therefore, by allocating hierarchical data streams to different bits, the broadcasting base station device 1 can provide distinct differences in error rate between data streams of different levels.

By reducing the constellation shown in FIGS. 5(a) to 5(d) further, one can finally get a QPSK constellation shown in FIGS. 3(a) and 3(b). This means that each symbol point in the latter represents four symbol points in the former. Therefore, the error rate in the determination of the b1 and b2 bits is a minimum, and the error rate in the determination of the b3 and b4 bits is a maximum. The allocated data streams cannot be obtained by demodulation.

The invention will be described in the following assuming that the above data allocation is employed. However, the description is not intended to be limiting the invention, since the bit allocation is up to the entity involved.

(Allocating Data)

To modulate a broadcast program with QPSK, the broadcasting base station device 1 splits a broadcast program data streams into, for example, a first level data stream and a second level data stream for hierarchical modulation. The first level data stream is a minimum data stream required to produce demodulation data by demodulation. The second level data stream is a supplementary data stream required to produce demodulation data of higher quality.

The broadcasting base station device 1 allocates the first level data stream to b1 and b2 and the second level data stream to b3 and b4. As mentioned earlier, in 16QAM, the error rate for b1 and b2 is lower than that for b3 and b4. Therefore, the error rate in the determination of bits for the first level data stream is lower than that for the second level data stream. Put differently, the probability of correctly receiving the first level data stream is greater than the probability of correctly receiving the second level data stream. Therefore, if propagation conditions are good in the service area, the mobile terminal device 2 can demodulate both the first level data stream and the second level data stream, thereby receiving relatively high quality data. Under poor propagation conditions, the mobile terminal device 2 can still demodulate the first level data stream, thereby receiving data with low, but acceptable quality.

In addition, if mobile terminal devices 2 on the boundary of a service area (cell edge) can receive data with some stable quality, more mobile terminal devices 2 can receive data with relatively high quality. In contrast, the mobile terminal devices 2 can receive minimally required data even under poor communication conditions.

(Changing Hierarchical Modulation Setup)

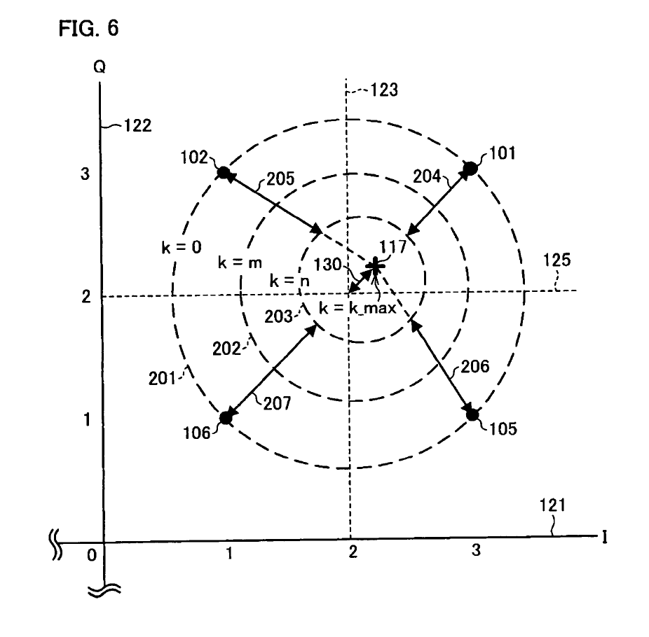

Next, referring to FIG. 6, the constellation to which the hierarchical modulation setup section 17 will make changes will be described in detail. FIG. 6 is a diagram illustrating a method of altering a constellation which is executed by the hierarchical modulation setup section 17.

FIG. 6 represents only the first quadrant of the constellation diagram in the I-Q plane. The hierarchical modulation setup section 17 changes symbol points in each of the four quadrants with the same method as the method for changing symbol points in the first quadrant.

As mentioned earlier, a hierarchical modulation section 12 modulates a broadcast program by uniform constellation 16QAM. The 16QAM used by the hierarchical modulation section 12 is based on a constellation of symbol points 101, 102, 105, and 106. Specifically, four bits b1, b2, b3, and b4 are allocated to each symbol point in such a manner that each symbol point represents a signal which differs from its adjacent symbol points only by 1 bit. That is, the symbol points are gray encoded.

On the other hand, to modulate broadcast signals by QPSK for transmission, the hierarchical modulation section 12 uses QPSK based on a constellation including symbol point 117. The average transmission power involved in the QPSK is equal to that involved in the 16QAM.

The hierarchical modulation setup section 17 changes the constellation by changing an offset factor k (detailed later). For example, when the offset factor k is 0, the hierarchical modulation setup section 17 decides to use a constellation with symbol points located on a circle 201. If the offset factor k is m. The section 17 decides to use a constellation with symbol points located on a circle 202. If the offset factor k is n, the section 17 decides to use a constellation with symbol points located on a circle 203. In any of the cases, the hierarchical modulation setup section 17 decides to use a 16QAM constellation with different degrees of spreading of the symbol points.

The circle becomes smaller with an increase of the offset factor k. Therefore, the circle ultimately converges to the symbol point 117, providing a QPSK constellation. In other words, in QPSK, the four symbol points on each circle are all represented by the symbol point 117. In the FIG. 6 example, the hierarchical modulation setup section 17 decides to use a constellation with the symbol point 117 when the offset factor k is k_max.

As mentioned earlier, the hierarchical modulation setup section 17 decides the positions of the symbol points in the constellation diagram according to the magnitude of the offset factor k. In the FIG. 6 example, the hierarchical modulation setup section 17 distributes the symbol points on three different circles in accordance with according to the value of the offset factor k. The number of circles is not limited to three. In other words, it would be sufficient if the hierarchical modulation setup section 17 decides the number of circles on which the symbol points are located, depending on the capability of the broadcasting base station device 1 and the improvement of reception quality.

The hierarchical modulation setup section 17 calculates the I and Q parts of each of the 16 symbol points in the 16QAM constellation from the following set of expressions:
−3+k(1−A)/r
−1−k(1+A)/r
+1+k(1+A)/r
+3−k(1−A)/r
where A=√5−2, k is the offset factor and equal to a positive integer from 1 to k_max inclusive, and the reciprocal of r is the resolution with which a broadcast program is modulated. In the FIG. 6 example, r=3 AND r=k_max.

Although not shown in the figures, to modulate a pilot signal, the broadcasting base station device 1 uses a modulation scheme which requires relatively low reception quality, such as BPSK. The broadcasting base station device 1 uses the pilot signal in various synchronization processes, for reception quality measurement in the mobile terminal device 2, and for reception signal gain control in the receiver.

When k=0, the four-symbol-point constellation matches with that of normal 16QAM, that is, the symbol points are located on the circle 201. When k=1, the four-symbol-point constellation is tightly squeezed than that of normal 16QAM (where the symbol points are separated from each other by equal distances), that is, the symbol points are located on the circle 202 which is smaller than the circle 201 by one size.

In this manner, the value of k is inversely proportional to the size of the circle connecting the four symbol points. Therefore, when k=r, the concentric circle converges to the symbol point 117, and the four-symbol-point constellation matches with a QPSK constellation.

In the FIG. 6 example, the hierarchical modulation setup section 17 ultimately decides on use of the QPSK constellation by increasing the value of the offset factor k. However, the section 17 does not necessarily ultimately decide on use of the QPSK constellation. The section 17 may ultimately decide on any constellation between the uniform 16QAM and the QPSK. That is, the only requirement is k_max<r.

Increasing the offset factor k improves the error rate in the determination of the b1 and b2 bits. Doing so, however, degrades the error rate in the determination of the b3 and b4 bits.

Typically, the broadcasting base station device 1 selects a modulation scheme to be used regardless of the magnitude of the average transmission power. The broadcasting base station device 1 may however use a QPSK constellation with the same average transmission power. The broadcasting base station device 1 can alter the constellation separately from the control of the transmission power. Therefore, even when the transmission power is uncontrollable, the device 1 is able to make subtle changes to the constellation in accordance with changing reception quality of broadcast signals. In addition, the average transmission power remains unchanged before and after alteration of the constellation; the broadcast signals transmitted from the device 1 are thus prevented from interfering with those transmitted from another, adjacent device 1.

(Normalization Factor or Constant)

The hierarchical modulation setup section 17 may multiply the I and Q parts of part each symbol point with a predetermined normalization factor (constant) By doing so, the average transmission power consumption in the transmission of the modulated broadcast signals can be rendered the same regardless of the modulation scheme employed. The hierarchical modulation setup section 17 uses different normalization factors (constants) for different modulation schemes as shown in the table below.

TABLE 1

| Modulation | Normalization factor |
|---|---|
| BPSK | 1 |
| QPSK | 1 ÷ √2 |
| 16QAM | 1 ÷ √10 |
| 64QSM | 1 ÷ √42 |

The average transmission power here refers to the means power consumption in the transmission of the modulated broadcast signals. Since the average transmission power is the same, the broadcasting base station device 1 can reduce interference between the broadcast signals it transmits and those transmitted from another, adjacent device 1 even when the constellation is altered.

(Use of BPSK)

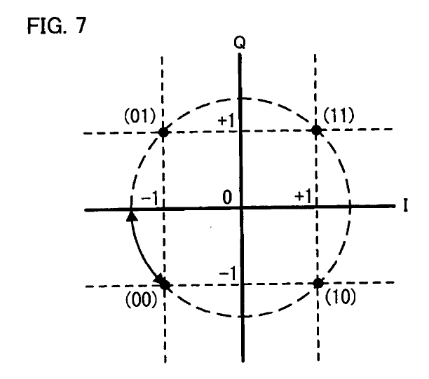

As mentioned earlier, the hierarchical modulation setup section 17 alters the constellation between QPSK and 16QAM. However, this is not the only way that the hierarchical modulation setup section 17 can alter the constellation. For example, the hierarchical modulation setup section 17 may alter the constellation between BPSK and QPSK as shown in FIG. 7.

(Broadcast System Details)

Referring to FIG. 1, the following will describe in detail a broadcast system including the broadcasting base station device 1. FIG. 1 is a block diagram illustrating a broadcast system of the present embodiment in detail. As shown in the figure, the broadcast system includes the broadcasting base station device 1, the mobile terminal device 2, a communications base station device 3, and a broadcast program providing center 4.

The broadcast program providing center 4 provides the broadcasting base station device 1 with a broadcast program. The broadcasting base station device 1 modulates the broadcast program to generate broadcast signals for transmission to the mobile terminal device 2. The mobile terminal device 2 receives the broadcast signals transmitted from the broadcasting base station device 1 and demodulates the received broadcast signals to restore the broadcast program. The mobile terminal device 2 displays the broadcast program on a display device (not shown). Thus, the system enables the user carrying the mobile terminal device 2 to view the broadcast program broadcast by the broadcasting base station device 1 while on the move. The communications base station device 3 receives data transmitted from the mobile terminal device 2 and also delivers the received data to the broadcasting base station device 1 over a communications network 5. In this manner, the communications base station device 3 serves as a relay station which relays various data collected by the broadcasting base station device 1 from the mobile terminal device 2.

(Details of Broadcasting Base Station Device 1)

Next, the broadcasting base station device 1 will be described in detail. As shown in FIG. 1, the broadcasting base station device 1 includes a broadcast program input section 11, a hierarchical modulation section 12, a broadcast signal transmitter section 13, a broadcast antenna 14, a data communications section 15, a quality distribution database 16, a hierarchical modulation setup section 17 (reception quality comparing means, hierarchical modulation setup means), and a reference quality database 18.

(Broadcast Program Input Section 11)

As mentioned earlier, the broadcast program providing center 4 provides a broadcast program to the broadcasting base station device 1. In the broadcasting base station device 1, the broadcast program input section 11 receives the provided broadcast program. The broadcast program input section 11 outputs the received broadcast program to the hierarchical modulation section 12.

(Hierarchical Modulation Section 12)

The hierarchical modulation section 12 modulates the broadcast program using a hierarchical modulation scheme set up by the hierarchical modulation setup section 17. Specifically, the hierarchical modulation section 12 is fed with constellation data generated by the hierarchical modulation setup section 17. The hierarchical modulation section 12 allocates broadcast program data to the symbol points in the constellation represented by the data. Specifically, the section 12 allocates the multiple hierarchical data streams to multiple different bits of a multilevel-modulation symbol. That is, the section 12 allocates a minimally required data stream to the first 2 bits of the symbol points with a lower error rate and a supplementary data stream to the last 2 bits with a higher error rate. The hierarchical modulation section 12 outputs a modulated broadcast program to the broadcast signal transmitter section 13.

(Broadcast Signal Transmitter Section 13, Broadcast Antenna 14)

The broadcast signal transmitter section 13 transmits the modulated broadcast program in the form of broadcast signals to the mobile terminal device 2 via the broadcast antenna 14. The broadcast antenna 14 may be anything that can output broadcast signals in 360°. Alternatively, for example, the antenna 14 may be such that it outputs broadcast signals in any degrees than less 360°. There may be involved a plurality of such antennas.

(Data Communications Section 15)

As mentioned earlier, the communications base station device 3 receives quality data and location data transmitted from the mobile terminal device 2 and sends the data to the broadcasting base station device 1 over the communications network 5. In the broadcasting base station device 1, the data communications section 15 receives the quality and location data from the communications base station device 3. The data communications section 15 records the received quality and location data in the quality distribution database 16 in such a manner that the two sets of data are associated with each other.

(Quality Distribution Database 16)

As mentioned earlier, the mobile terminal device 2 informs the broadcasting base station device 1 of the current location of the mobile terminal device 2 in the service area of the broadcasting base station device 1. In other words, the location of the mobile terminal device 2 corresponds to a predetermined location in the service area of the broadcasting base station device 1. Accordingly, the quality distribution database 16 contains the location data, representing locations in the service area of the broadcasting base station device 1, and the quality data, representing reception quality of broadcast signals measured at those locations, in such a manner that the two sets of data are associated with each other.

Incidentally, the mobile terminal device 2 may transmit the broadcasting base station device 1 information on its operational state (e.g., engaged, standing by, or downloading data) and also on its orientation (e.g., the direction of the antenna, whether it is open or folded) when reception quality is measured. When this is the case, the broadcasting base station device 1 records the information in the quality distribution database 16 in association with the quality data and the location data.

(Reference Quality Database 18)

Reference quality in broadcast signal reception at locations in the service area is specified in advance in the broadcasting base station device 1. The reference quality at a location refers to required, optimal reception quality of the broadcast signals received by the mobile terminal device 2 at that location. If the reception quality of the broadcast signals received by the mobile terminal device 2 at a location is higher than the reference quality at the location, which the broadcasting base station device 1 is set up to achieve, the broadcasting base station device 1 regards the current propagation conditions of the broadcast signals as being optimal.

The reference quality and related information is stored in the reference quality database 18. Specifically, the reference quality database 18 contains the location data, representing locations in the service area of the broadcasting base station device 1, and the reference quality data, representing the reference quality at those locations, in such a manner that the two sets of data are associated with each other. For example, the reference quality data gives “80” as the reference quality at locations a hundred meters from the broadcasting base station device 1 and “60” as the reference quality at locations five hundred meters from the broadcasting base station device 1.

(Hierarchical Modulation Setup Section 17)

The hierarchical modulation setup section 17 decides the details of the hierarchical modulation scheme to be used by the hierarchical modulation section 12. Based on the quality of the broadcast signals received by the mobile terminal device 2, the section 17 specifies a hierarchical modulation scheme which best suits the current reception quality. Specifically, the hierarchical modulation setup section 17 retrieves the quality and location data from the quality distribution database 16. The section 17 then retrieves, from the reference quality database 18, the reference quality data associated with the location data retrieved from the quality distribution database 16.

The hierarchical modulation setup section 17 compares the reception quality of the broadcast signals measured at a location found in the quality data to the reference quality of the broadcast signals at the location found in the reference quality data. The comparison determines, for example, whether the reception quality is higher than reference quality. It is preferable if the hierarchical modulation setup section 17 makes that determination based on a mean value of reception quality provided by a plurality of mobile terminal devices 2.

If the hierarchical modulation setup section 17 has determined that the reception quality is lower (poorer) than the reference quality, the hierarchical modulation setup section 17 changes the difference in error rate between multiple different bits to an increased value. The change increases the error rate for which the error rate was originally high and decreases the error rate for the bits for which the error rate was originally low. On the other hand, if the reception quality is determined to be higher (better) than the reference quality, the section 17 changes the difference in error rate between the multiple different bits to a decreased value. The change decreases the error rate for the bits for which the error rate was originally high and increases the error rate for the bits for which the error rate was originally low.

Specifically, if the reception quality is determined to be lower than the reference quality, the hierarchical modulation setup section 17 reduces the hierarchical modulation scheme constellation in each quadrant by one size. Specifically, the hierarchical modulation setup section 17 does so by switching the offset factor from the current value to the value plus 1. On the other hand, if the reception quality is determined to be higher than the reference quality, the section 17 enlarges the hierarchical modulation scheme constellation in each quadrant by one size. Specifically, the section 17 does so by switching the offset factor from the current value to the value minus 1.

The hierarchical modulation setup section 17 substitutes the new offset factor in the aforementioned expressions and calculates new I and Q parts for the symbol points. A constellation reduced in each quadrant is thus determined.

The hierarchical modulation setup section 17 generates data representing the determined constellation for output to the hierarchical modulation section 12. The hierarchical modulation section 12 modulates the broadcast program under the hierarchical modulation scheme of the constellation represented by the input constellation data. In other words, the hierarchical modulation section 12 uses the hierarchical modulation scheme of the new constellation determined by the hierarchical modulation setup section 17.

(Offset Factor Data)

In the broadcasting base station device 1, the offset factor data representing a predetermined offset factor k is stored in predetermined memory (not shown). This offset factor is the factor used when the hierarchical modulation setup section 17 alters the constellation. The distribution of the constellation in each quadrant, that is, the distribution of the symbol points in the I-Q plane, is decided in accordance with the value of the offset factor.

(Details of Mobile Terminal Device 2)

Next, the mobile terminal device 2 will be described in detail. As shown in FIG. 1, the mobile terminal device 2 includes a broadcast signal receiver section 21, a location information collecting section 22, a reception quality analyzer section 23, and a data communications section 24.

(Broadcast Signal Receiver Section 21)

The broadcast signal receiver section 21 receives broadcast signals transmitted from the broadcasting base station device 1. The broadcast signal receiver section 21 outputs the received broadcast signals to the reception quality analyzer section 23. Under good reception conditions, the mobile terminal device 2 can demodulate substantially all the transmission signals. Under poor reception conditions, the device 2 can demodulate only some of the transmission signals.

(Location Information Collecting Section 22)

The location information collecting section 22 collects information on the current location of the mobile terminal device 2 by a certain means, such as the GPS (Global Positioning System) system. The location information collecting section 22 generates location data representing the current location for output to the data communications section 24.

(Reception Quality Analyzer Section 23)

The reception quality analyzer section 23 measures the reception quality of the received broadcast signals. The reception quality analyzer section 23 generates quality data representing the measured reception quality for output to the data communications section 24.

The reception quality analyzer section 23 may be anything that can measure the reception quality of the broadcast signals by a certain means. For example, the reception quality analyzer section 23 may measure the reception quality based on the signal strength of the broadcast signals upon reception. Alternatively, the section 23 may do so based on the error rate in the demodulation of the broadcast signals.

(Data Communications Section 24)

The data communications section 24 transmits the input quality and location data to a communications base station device 3 present within a data communicable range. Although not illustrated in the figure, information on the operational state (communications state), orientation, etc. of the mobile terminal device 2 may be transmitted simultaneously. The data communications section 24 transmits the sets of data at predetermined intervals. Alternatively, the data communications section 24 may transmit the quality and location data to the communications base station device 3 when the mobile terminal device 2 determines that the reception quality of the broadcast signals has dropped below a predetermined value. In a further alternative, the data communications section 24 may do so when it is determined from the location data that the mobile terminal device 2 is at a predetermined location.

(Altering Hierarchical Modulation Schemes)

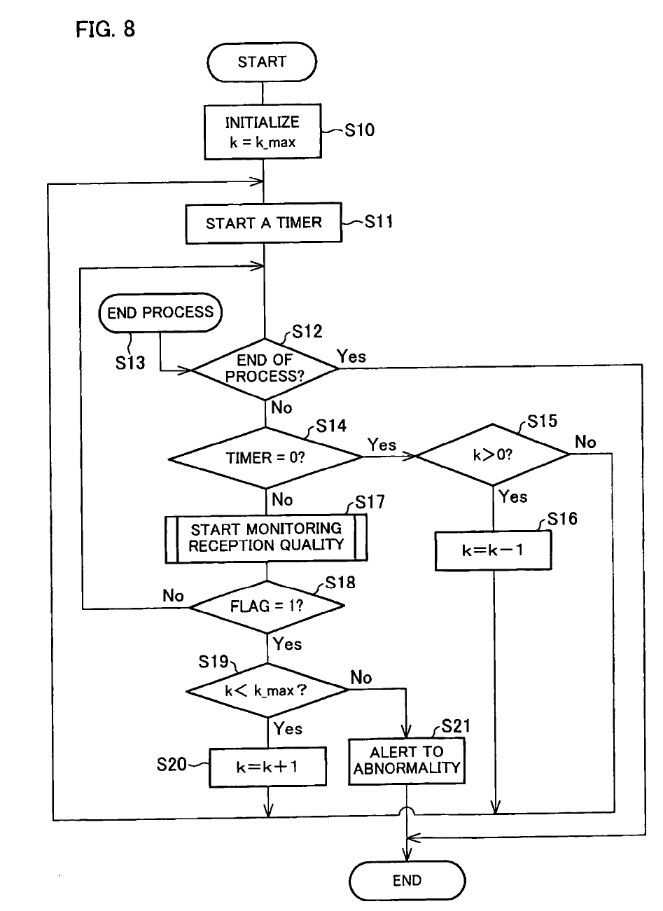

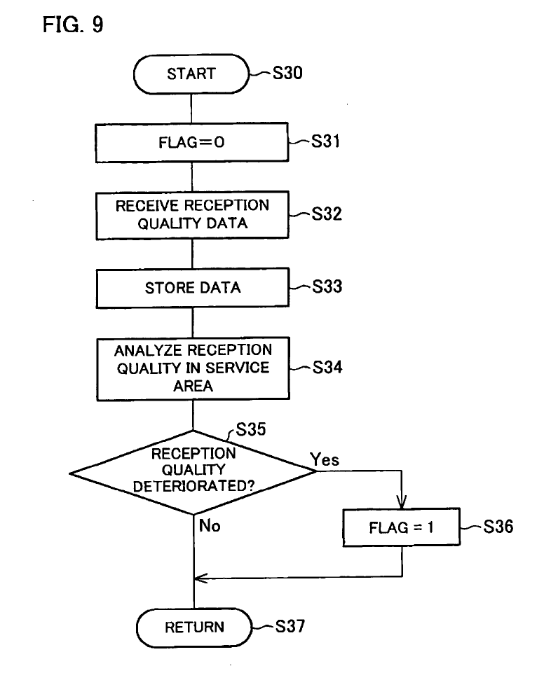

Referring to FIGS. 8 and 9, the following will describe a process by which the broadcasting base station device 1 alters hierarchical modulation schemes. FIG. 8 is a flow chart representing a process flow by which the broadcasting base station device 1 to alter hierarchical modulation schemes.

As shown in FIG. 8, the broadcasting base station device 1 first initializes the offset factor k (step 10). Specifically, the device 1 sets the offset factor k to “k_max” and stores this value setting of the offset factor k in predetermined memory (not shown).

The broadcasting base station device 1 then starts a timer (step 11). Specifically, the device 1 measures time by setting a timer to a predetermined initial value greater than 0 and decrementing the timer value by 1 at fixed intervals. Accordingly, the broadcasting base station device 1 monitors the quality of the broadcast signals as received by the mobile terminal device 2 for a predetermined period.

Following the start of the timer, the broadcasting base station device 1 determines whether to end the process (step 12). If there is an express command input from the user to end the process, for example, the broadcasting base station device 1 ends the process (step 13).

If it is determined in step 12 that the process is yet to be ended, the hierarchical modulation setup section 17 determines whether the timer value is “0” (step 14). If the timer is determined to be indicating “0,” the hierarchical modulation setup section 17 checks the current value of the offset factor k. Specifically, it is determined whether the current value of the offset factor k is smaller than the maximum selectable value to the hierarchical modulation setup section 17. The maximum value is stored in the reference quality database 18 in advance.

If the offset factor k is determined to be greater than “0,” the hierarchical modulation setup section 17 replaces the current value of the offset factor k contained in predetermined memory (not shown) with the value minus 1 (step 16). Next, the process returns to step 11 where the timer is started.

On the other hand, if the current offset factor k is determined to be not greater than “0,” the hierarchical modulation setup section 17 does not changes its value. That is, the process returns to step 11 where the timer is started again.

(Monitoring of Reception Quality)

If the timer is determined in step 14 to be indicating not “0.” the broadcasting base station device 1 starts monitoring the reception quality (step 17). The following will describe this reception quality monitoring, performed by the broadcasting base station device 1, in reference to FIG. 9. FIG. 9 is a flow chart representing a process flow that the broadcasting base station device 1 performs to monitor the quality of the broadcast signals as they are received by the mobile terminal device 2.

As shown in FIG. 9, following the start of the reception quality monitoring (step 30), the broadcasting base station device 1 sets a flag in predetermined memory (not shown) to “0” (step 31). The flag indicates either the offset factor k, which dictates the hierarchical modulation constellation, is to be enlarged or reduced.

Next, the data communications section 15 receives the quality data representing the reception quality of the broadcast signals from the mobile terminal device 2 via the communications base station device 3 (step 33). At the same time, the data communications section 15 receives also the location data representing the location of the mobile terminal device 2. The data communications section 15 stores the received quality data and location data in the quality distribution database 16 (step 33).

Next, the hierarchical modulation setup section 17 analyzes the reception quality of the broadcast signals in the service area of the broadcasting base station device 1 (step 34). Specifically, the hierarchical modulation setup section 17 determines whether the reception quality of the broadcast signals at a location in the service area is lower than the predetermined reference quality at that location, by using the quality data contained in the quality distribution database 16 and the reference quality data contained in the reference quality database 18.

Here, if the reception quality is determined to be lower than the reference quality, the hierarchical modulation setup section 17 determines that the reception quality at the location of the mobile terminal device 2 has dropped (step 35). Accordingly, the hierarchical modulation setup section 17 changes the flag to “1” (step 36). On the other hand, if the reception quality is determined to be higher than the reference quality, the hierarchical modulation setup section 17 does not change the value of the flag, allowing it to remain at “0.”

This brings the reception quality monitoring by the broadcasting base station device 1 to an end (step 37).

Next, the process performed by the broadcasting base station device 1 after the end of the reception quality monitoring is described in reference again to FIG. 8. After the end of the reception quality monitoring, the broadcasting base station device 1 determines the value of the flag contained in memory. That is, it is determined whether or not the flag is “1” (step 18). If the flag is determined to be “0,” not “1,” the broadcasting base station device 1 returns to step 12 where the device 1 determines whether to end the process. As mentioned earlier, the “0” flag indicates that the reception quality of the broadcast signals has not dropped. Therefore, when the flag is 0, the hierarchical modulation setup section 17 does not change the value of the offset factor k.

On the other hand, if the flag is determined to be “1,” the hierarchical modulation setup section 17 checks the value of the offset factor k. Specifically, it is determined whether the offset factor k is smaller than an allowed maximum value (step 19). If the offset factor k is determined to be not smaller than the allowed maximum value, the hierarchical modulation setup section 17 displays on a predetermined display device (not shown) an alert to the occurrence of an abnormality. With the display, the broadcasting base station device 1 ends the process and waits for maintenance by an administrator.

On the other hand, if the offset factor k is determined to be smaller than the allowed maximum value, the hierarchical modulation setup section 17 replaces the value of the offset factor k contained in memory with the value plus 1 (step 20). Thus, the hierarchical modulation setup section 17 reduces the constellation for the hierarchical modulation scheme to be used by the hierarchical modulation section 12 by one size. After changing the value of the offset factor k, the hierarchical modulation setup section 17 returns to step 11 where the timer is started again.

(Function and Effects)

As mentioned earlier, the hierarchical modulation setup section 17 decides a hierarchical modulation scheme for the modulation of broadcast signals on the basis of comparison of reception quality to reference quality. For example, if the reception quality at the location of a mobile terminal device 2 is determined to be lower than the predetermined reference quality, the hierarchical modulation setup section 17 alters hierarchical modulation schemes for a constellation reduced in each quadrant for use by the hierarchical modulation section 12. This alteration improves error rate in bit determination as to minimally required data, enabling the broadcast signals which can be demodulated for minimally required data to reach mobile terminal devices 2 located further from the broadcasting base station device 1. That is, the service area of the broadcasting base station device 1 can be expanded. In the alteration, the hierarchical modulation setup section 17 selects a constellation in which reception quality at the location of the mobile terminal devices 2 which have forwarded the reception quality is not below the reference quality.

In addition, if the reception quality at the location of a mobile terminal device 2 is determined to be higher than the reference quality, the hierarchical modulation setup section 17 alters hierarchical modulation schemes for a constellation enlarged in each quadrant, for example, for use by the broadcasting base station device 1. This alteration improves error rate in bit determination as to a supplementary data stream, which in turn will likely improve on the reception quality of the broadcast program as received by the mobile terminal device 2 located far from the base station device 1 in view of the quality prior to the constellation alteration.

In this manner, the broadcasting base station device 1 flexibly alters hierarchical modulation schemes for use in broadcast signal modulation in accordance with whether the reception quality of the broadcast program at the mobile terminal device 2 receiving the broadcast signals is good or poor. Accordingly, the device 1 can transmit to the mobile terminal devices 2 optimal broadcast signals in accordance with the actual reception quality of the broadcast signals.

The present invention is not limited to the embodiment, but may be altered by a skilled person within the scope of the claims. An embodiment based on a proper combination of technical means disclosed in claims is encompassed in the technical scope of the present invention.

(Using Mean Values of Multiple Sets of Data)

The broadcasting base station device 1 may during a predetermined period be dedicated to collect the quality and location data transmitted from the mobile terminal devices 2. When this is the case, the broadcasting base station device 1, during that period, collects many sets of quality and location data transmitted from multiple mobile terminal devices 2 located at various locations in the service area. Therefore, the broadcasting base station device 1 is able to create a precise reception quality map which represents reception quality distribution actually measured in its service area as part of the quality distribution database. Accordingly, following the predetermined period, the hierarchical modulation setup section 14 can make a comprehensive decision in view of the reception quality situation of the entire service area by comparing the reception quality sequentially at locations in the service area which is contained in the quality distribution database to the reference quality contained in the reference quality database, so as to specify the difference in error rate in bit determination between the multiple different bits (distribution of the hierarchical modulation constellation). Therefore, the section 14 can specify a more suitable hierarchical modulation scheme.

(Batch Collection of Reception Quality Data)

If the reception quality is determined to be lower than the reference quality, the broadcasting base station device 1 may transmit a predetermined instruction signal to all the mobile terminal devices 2 in the service area. To do so, the device 1 transmits to the mobile terminal devices 2, for example, an instruction to measure reception quality at their locations and transmit the measurements to the broadcasting base station device 1. Accordingly, the broadcasting base station device 1 can collect more data on the reception quality of the broadcast signals at those locations where the reception quality is determined to be lower than the reference quality. More information is therefore available in the determination of constellation changes. A more suitable constellation can be determined for use.

(Offset Factor k)

In the broadcasting base station device 1, memory may contain data which represents hierarchical modulation scheme types and multiple sets of offset factor data which is each used when deciding a constellation for a particular hierarchical modulation scheme in such a manner to mutually associate the data. When this is the case, the multiple sets of offset factor data contained in the memory represents offset factors of respectively different values. Therefore, for the broadcasting base station device 1, different offset factors are defined in advance for each hierarchical modulation scheme. For example, for 16QAM, offset factors of five different values are defined in advance. Using these offset factors of different values, the hierarchical modulation setup section 17 can specify, for example, five types of 16QAM, each with a different constellation, as the hierarchical modulation scheme to be used by the hierarchical modulation section 12.

(Transmission Data)

The data communications section 24 may transmit data which represents the reproduction state of a received moving image to the communications base station device 3 as the quality data. Alternatively, the data communications section 24 may transmits data which represents a storage state of the moving image to the communications base station device 3 as the quality data. Further, if the mobile terminal device 2 has a voice communication function over a telephone line, the quality data may be transmitted to the mobile terminal device 2 together with data representing the operational state of the mobile terminal device 2 (engaged, standing by, etc.). Accordingly, in the broadcasting base station device 1, the data communications section 15 can collect data representing various information on the mobile terminal device 2 and store the data in the quality distribution database 16.

(Number of Hierarchical Levels)

The hierarchical modulation setup section 17 is not limited to specify only 2-level hierarchical modulation. In other words, the hierarchical modulation setup section 17 may specify a modulation scheme involving any number of hierarchical levels. For example, a constellation may be specified somewhere between 16QAM and 64QAM to employ a hierarchical modulation scheme involving 3 hierarchical levels.

(Reception Quality Measurement)

The reception quality analyzer section 23 may measure the reception quality of the broadcast signals by any means. For example, the reception quality analyzer section 23 may measure the reception quality on the basis of the strength of radio broadcast signals. When this is the case, the strength of radio broadcast signals may be standardized as the reception quality. Besides, the reception quality analyzer section 23 may measure predetermined parameters which are derived from the received broadcast signals, such as the S/N ratio (signal to noise ratio), C/N ratio (carrier to noise ratio), transmission power upon reception, signal strength upon reception, and error rate of the broadcast signals, as the reception quality of the broadcast signals.

(Notifying Reception Quality at Particular Location)

The data communications section 24 may notify the broadcasting base station device 1 of the reception quality only when the section 24 is located at a predetermined location. That particular location is, for example, on the perimeter of the service area coverage by the broadcasting base station device 1. The data representing the location is contained in advance in predetermined memory (not shown) in the data communications section 24. The data communications section 24 is instructed by, for example, the broadcasting base station device 1 as to the location at which the section 24 must measure the reception quality of the broadcast signals and notify the broadcasting base station device 1 of it.

When this is the case, the data communications section 24 notifies the broadcasting base station device 1 of the reception quality only when particular conditions are met: i.e., only when the mobile terminal device 2 is at the particular location. The mobile terminal device 2 avoids to unconditionally notify the broadcasting base station device 1 of the reception quality. Accordingly, the amount of information processed in notifying the broadcasting base station device 1 of the reception quality is decreased.

(Notifying of Reception Quality Below Threshold)

The data communications section 24 may notify the broadcasting base station device 1 of the reception quality and the location of the mobile terminal device 2 when the reception quality of the broadcast signals measured by the reception quality analyzer section 23 is lower than a predetermined threshold. The threshold-representing data is contained in advance in predetermined memory (not shown) in the data communications section 24. The mobile terminal device data communications section 24 does not notify the broadcasting base station device 1 of the reception quality when the reception quality is determined to be good. Therefore, the amount of information processed in notifying the broadcasting base station device 1 of the reception quality is decreased.

The data communications section 24 may perform the above processes in combinations.

(Automatic Measurement of Reception Quality)

The mobile terminal device 2 is not capable of predicting in advance when and where the user views the broadcast program. Therefore, if the reception quality is measured and the broadcasting base station device 1 is notified of the measurements only when the user is viewing the broadcast program, inconveniences follows. Specifically, if the terminal is not receiving any broadcast programs when the mobile terminal device 2 is located at a location at which the device 2 should notify the broadcasting base station device 1 of the reception quality, the broadcasting base station device 1 is not notified of the reception quality. Therefore, the broadcasting base station device 1 cannot collect sufficiently reception quality data for the service area.

Accordingly, the reception quality analyzer section 23 may, when necessary, automatically measure the reception quality from the received broadcast signals even when the terminal is not receiving any broadcast programs and/or the user is not viewing a broadcast program. For example, it is determined that the mobile terminal device 2 is located at a location at which the device 2 should notify the broadcasting base station device 1 of the reception quality, the reception quality analyzer section 23 instructs the broadcast signal receiver section 21 to receive the broadcast signals. Thus, the broadcast signal receiver section 21 receives the broadcast signals and outputs to the reception quality analyzer section 23 even when the terminal is not receiving any broadcast programs. The reception quality analyzer section 23 measures the reception quality of the broadcast signals by the aforementioned predetermined method and notifies the broadcasting base station device 1 via the data communications section 24.

Accordingly, the mobile terminal device 2 can reliable notify the broadcasting base station device 1 of the reception quality of the broadcast signals at the predetermined location.

(OFDM Application)

The present invention is applicable to OFDM (orthogonal frequency division multiplexing). To do so, the hierarchical modulation setup section 17 may specify the individual narrow bandwidth modulation schemes used in OFDM as the hierarchical modulation schemes by the aforementioned method.

(Instruction as to Location at which Reception Quality is Measured)

The broadcasting base station device 1 may instruct the mobile terminal device 2 as to the location at which the device 2 will measure the reception quality and notify the broadcasting base station device 1. When this is the case, the reception quality analyzer section 23 starts measuring the reception quality of the broadcast signals when the mobile terminal device 2 is at the instructed location. Therefore, the broadcasting base station device 1 can collect the reception quality of the broadcast signals at desired locations.

(Other Arrangements)

The present invention may be adapted as in the following first to ninth arrangements.

(First Arrangement)

A wireless broadcast station device being characterized in that the wireless broadcast station device wireless broadcasts information to multiple terminals and has an uplink to obtain information from the terminals, the wireless broadcast station device including: a propagation environment analysis device for obtaining at least reception quality information and reception position information from the terminal stations and recording the information in a database; a monitor device for monitoring the database information and selecting one constellation for any given period from those specified for the modulation for hierarchical modulation; and a transmission control device for obtaining hierarchical information to be transmitted and modulating with the selected constellation.

(Second Arrangement

The wireless broadcast station device of the first arrangement characterized in that the multiple constellations of the same average transmission power are used.

(Third Arrangement)

The wireless broadcast station device of either the first or second arrangements characterized in by the further inclusion of a high frequency transmitter device for transmission power control, wherein at least either the constellation alteration or the transmission power control is done at the control timings.

(Fourth Arrangement)

The wireless broadcast station device of any one of the first to third arrangements characterized in that an OFDM (orthogonal frequency division multiplexing) scheme is used.

(Fifth Arrangement)

The wireless broadcast station device of any one of the first to fourth arrangements characterized in that it notifies the terminal of a location where the terminal should report the reception quality.

(Sixth Arrangement)

A wireless terminal device being characterized in that it receives broadcast from the wireless broadcast station device of any one of the first to fifth arrangements, wherein the wireless terminal device notifies of the receive situation only when the wireless terminal device is located at a location specified in advance.

(Seventh Arrangement)

A wireless terminal device being characterized in that it receives broadcast from the wireless broadcast station device of any one of the first to fifth arrangements, wherein the wireless terminal device notifies the wireless broadcast device of the reception quality information and reception position information when the reception quality is lower than a specified threshold.

(Eighth Arrangement)

A terminal device characterized in that it turns to a reception state when it is located at a location where it should report even if it is not in a program viewing state, starts reception quality measurement, and notifies the wireless broadcast device of any one of the first to fifth arrangements as well as location information and terminal state information.

(Ninth Arrangement)

A hierarchical modulation control method characterized by the steps of: monitoring reception quality from a terminal for any given period; if, as a result, there is no location in the service area where reception quality is below a requested target, increasing request reception signal quality of the first level data and selecting a constellation used in such a manner so that the request reception signal quality of the second level data decreases; and on the other hand, if there is a location where the reception quality is below a requested target, decreasing the request reception signal quality of the first level data and selecting a constellation used in such a manner so that the request reception signal quality of the second level data increases.

(Computer Program and Storage Medium)

Finally, the blocks in the broadcasting base station device 1 may be constructed of hardware logic. Alternatively, they may be constructed of software using a CPU (central processing unit) as follows. The broadcasting base station device 1 includes a CPU executing instructions from a control program realizing the functions; a ROM (read only memory) containing the control program; a RAM (random access memory) to which the control program is loaded in an executable format; and a storage device (storage medium), such as memory containing the control program and various data.

With this structure, the objective of the present invention can be achieved using a predetermined storage medium. The storage medium only needs to contain the program code (executable program, intermediate code program, source program) of a control program for the broadcasting base station device 1 which is software realizing the aforementioned functions in a computer-readable manner. The broadcasting base station device 1 is provided with the storage medium. Accordingly, the broadcasting base station device 1 as a computer (or CPU or MPU) only needs to read the program code contained in the given storage medium.

The storage medium with which the program code is provided to the broadcasting base station device 1 is not limited to any particular structure or type. In other words, the storage medium may be, for example, a tape, such as a magnetic tape and a cassette tape; a disk including a magnetic disk, such as a floppy (registered trademark) disk and a hard disk, and an optical disc, such as a CD/MO/MD/DVD/CD-R; a card, such as an IC card (inclusive of a memory card) and an optical card; and a semiconductor memory, such as a mask ROM/EPROM/EEPROM/flash ROM.

The objective of the present invention may be achieved also if the broadcasting base station device 1 is so structured that it can connect to a communications network. When this is the case, the program code is fed to the broadcasting base station device 1 over the communications network. The communications network may be any network so long as it can provide the broadcasting base station device 1 with the program code. The network is not limited to any particular type or form. For example, the network may be the Internet, an Intranet, an Extranet, a LAN, ISDN, VAN, or CATV communications network, a Virtual Private Network, a telephone line network, a mobile communications network, a satellite communications network, etc.

The transmission medium for the communications network may be any medium that can transmit program code. The medium is not limited to any particular structure or type. Wired examples include IEEE1394, USB (Universal Serial Bus), power line transmission, cable TV line, telephone line, and ADSL (asymmetric digital subscriber line). Wireless examples include infrared, such as IrDA and remote control, Bluetooth (registered trademark), 802.11 wireless, HDR, mobile phone network, satellite link, terrestrial digital broadcast network.

Also, the present invention can be realized in the form of a computer data signal, embodied in a carrier wave, which represents the program code in electronic transmission.

In the broadcasting base station device in accordance with the present invention, it is preferable if when the reception quality at the location of the mobile terminal device is determined to be lower than the reference quality, the hierarchical modulation setup means specifies the difference in error rate in bit determination to an increased value.

According to the arrangement, when the reception quality at the location of the mobile terminal device is determined to be lower than the reference quality, the hierarchical modulation setup means changes the difference in error rate in bit determination in the hierarchical modulation scheme employed by the broadcasting base station device to an increased value. For example, the means changes to a hierarchical modulation scheme where the constellation is greater in each 16QAM quadrant. The change decreases the error rate for the bits for which the error rate was originally high, and on the other hand, increases the error rate for the bits for which the error rate was originally low.

In hierarchical modulation schemes, data used in a supplementary fashion in the demodulation of a broadcast program is allocated to lower bits. Accordingly, the error rate in bit determination for supplementary data improves. Therefore, mobile terminal devices located further from the broadcasting base station device can demodulate the broadcast program. In other words, the broadcasting base station device can send broadcast signals which can be demodulated for minimally required data to mobile terminal devices located further away from it.

In the broadcasting base station device in accordance with the present invention, it is preferable if when the reception quality at the location of the mobile terminal device is determined to be higher than the reference quality, the hierarchical modulation setup means specifies the difference in error rate in bit determination to a decreased value.

According to the arrangement, when the reception quality at the location of the mobile terminal device is determined to be higher than the reference quality, the hierarchical modulation setup means changes the difference in error rate in bit determination in the hierarchical modulation scheme employed by the broadcasting base station device to a decreased value. For example, the means changes to a hierarchical modulation scheme where the constellation is smaller in each 16QAM quadrant. The change decreases the error rate for the bits for which the error rate was originally high, and on the other hand, increases the error rate for the bits for which the error rate was originally low.

In hierarchical modulation schemes, data used in a supplementary fashion in the demodulation of a broadcast program is allocated to higher bits. Accordingly, the error rate in bit determination for supplementary data improves. In other words, the broadcasting base station device can send the broadcast program received by the mobile terminal device further with higher quality than before the change of the hierarchical modulation schemes.

In the broadcasting base station device in accordance with the present invention, it is preferable if the hierarchical modulation setup means specifies a hierarchical modulation scheme with a constellation where average transmission power remains unchanged.

According to the arrangement, the hierarchical modulation setup means specifies a hierarchical modulation scheme with a constellation where average transmission power remains unchanged. The average transmission power here refers to the average transmission power consumption in the transmission of the modulated broadcast signals. Since the average transmission power is the same, the average received transmission power of the mobile terminal device in the service area also remains unchanged before and after the change of the constellation. Therefore, the broadcasting base station device can reduce interference between the broadcast signals it transmits and those transmitted from another, adjacent broadcasting base station device.

In the broadcasting base station device in accordance with the present invention, it is preferable if it further includes instruction means for instructing the mobile terminal device as to a location at which the mobile terminal device notifies of the reception quality.

According to the arrangement, the instruction means instructs the mobile terminal device as to the location(s) where the mobile terminal device should measure the reception quality and notify the broadcasting base station device. The mobile terminal device starts measuring the reception quality of the broadcast signals when it moves into the instructed location. Therefore, the broadcasting base station device can collect the reception quality of the broadcast signals at desired locations.

The broadcasting base station device may be realized by a computer. When this is the case, the present invention encompasses within its scope a hierarchical modulation setup computer program realizing the broadcasting base station device on a computer by causing the computer to function as the various means and the computer-readable storage medium containing the computer program.

As described in the foregoing, the broadcasting base station device in accordance with the present invention includes the hierarchical modulation setup means which specifies a hierarchical modulation scheme on the basis of a result of the comparison of the reception quality and the reference quality. The broadcasting base station device thereby transmits optimal broadcast signals that matches with actual reception quality to the mobile terminal devices.

The present invention is widely applicable to broadcasting base station devices that broadcast broadcast programs modulated by a hierarchical modulation scheme to mobile terminal devices.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

What is claimed is:

1. A broadcasting base station device for transmitting to a mobile terminal device a broadcast signal modulated by a hierarchical modulation scheme whereby multiple hierarchical data streams are allocated respectively to multiple bits of a multilevel-modulation symbol, said station device comprising:
reception quality comparing means for comparing reception quality of the broadcast signal at a location of the mobile terminal device to predetermined reference quality; and
hierarchical modulation setup means for specifying a difference in error rate in bit determination between the multiple different bits on the basis of a result of the comparison by the reception quality comparing means.

2. The broadcasting base station device of claim 1, wherein when the reception quality at the location of the mobile terminal device is determined to be lower than the reference quality, the hierarchical modulation setup means specifies the difference in error rate in bit determination to an increased value.

3. The broadcasting base station device of claim 1, wherein when the reception quality at the location of the mobile terminal device is determined to be higher than the reference quality, the hierarchical modulation setup means specifies the difference in error rate in bit determination to a decreased value.

4. The broadcasting base station device of claim 1, wherein the hierarchical modulation setup means specifies a hierarchical modulation scheme with a constellation where average transmission power remains unchanged.

5. The broadcasting base station device of claim 1, further comprising instruction means for instructing the mobile terminal device as to a location at which the mobile terminal device notifies of the reception quality.

6. The broadcasting base station device of claim 1, wherein the hierarchical modulation setup means specifies the difference in error rate in bit determination between QPSK and 16QAM.

7. A mobile terminal device for notifying a broadcasting base station device of reception quality of a received broadcast signal, the broadcasting base station device transmitting to the mobile terminal device the broadcast signal after modulation by a hierarchical modulation scheme whereby multiple hierarchical data streams are allocated respectively to multiple bits of a multilevel-modulation symbol, the broadcasting base station device including: reception quality comparing means for comparing reception quality of the broadcast signal at a location of the mobile terminal device to predetermined reference quality; and hierarchical modulation setup means for specifying a difference in error rate in bit determination between the multiple different bits on the basis of a result of the comparison by the reception quality comparing means,
the mobile terminal device comprising reception quality notifying means for notifying the broadcasting base station device of the reception quality only when the mobile terminal device is located at a predetermined location.

8. A mobile terminal device for notifying a broadcasting base station device of reception quality of a received broadcast signal, the broadcasting base station device transmitting to the mobile terminal device the broadcast signal after modulation by a hierarchical modulation scheme whereby multiple hierarchical data streams are allocated respectively to multiple bits of a multilevel-modulation symbol, the broadcasting base station device including: reception quality comparing means for comparing reception quality of the broadcast signal at a location of the mobile terminal device to predetermined reference quality; and hierarchical modulation setup means for specifying a difference in error rate in bit determination between the multiple different bits on the basis of a result of the comparison by the reception quality comparing means,
the mobile terminal device comprising reception quality notifying means for notifying the broadcasting base station device of the reception quality and a location of the mobile terminal device when the reception quality is lower than a predetermined threshold.

9. A mobile terminal device for notifying a broadcasting base station device of reception quality of a received broadcast signal, the broadcasting base station device transmitting to the mobile terminal device the broadcast signal after modulation by a hierarchical modulation scheme whereby multiple hierarchical data streams are allocated respectively to multiple bits of a multilevel-modulation symbol, the broadcasting base station device including: reception quality comparing means for comparing reception quality of the broadcast signal at a location of the mobile terminal device to predetermined reference quality; and hierarchical modulation setup means for specifying a difference in error rate in bit determination between the multiple different bits on the basis of a result of the comparison by the reception quality comparing means,
the mobile terminal device comprising reception quality notifying means for notifying the broadcasting base station device of the reception quality when the mobile terminal device is located at a predetermined location at which the mobile terminal device should notify of the reception quality even if the terminal is not receiving any broadcast programs.

10. A broadcast system, comprising: a broadcasting base station device and a mobile terminal device,
the mobile terminal device notifying the broadcasting base station device of reception quality of a received broadcast signal,
the broadcasting base station device transmitting to the mobile terminal device the broadcast signal after modulation by a hierarchical modulation scheme whereby multiple hierarchical data streams are allocated respectively to multiple bits of a multilevel-modulation symbol, the broadcasting base station device including: reception quality comparing means for comparing reception quality of the broadcast signal at a location of the mobile terminal device to predetermined reference quality; and hierarchical modulation setup means for specifying a difference in error rate in bit determination between the multiple different bits on the basis of a result of the comparison by the reception quality comparing means,

11. A hierarchical modulation setup method of setting up a broadcasting base station device for a hierarchical modulation scheme whereby multiple hierarchical data streams are allocated respectively to multiple bits of a multilevel-modulation symbol, the broadcasting base station device modulating a broadcast signal by the hierarchical modulation scheme for transmission to a mobile terminal device, said method comprising the steps of:
(a) comparing the reception quality of the broadcast signal as received by the mobile terminal device to predetermined reference quality; and
(b) specifying a difference in error rate in bit determination between the multiple different bits on the basis of a result of the comparison in step (a).

12. A hierarchical modulation setup computer program for causing a broadcasting base station device to function as the various means, the broadcasting base station device for transmitting to a mobile terminal device a broadcast signal modulated by a hierarchical modulation scheme whereby multiple hierarchical data streams are allocated respectively to multiple bits of a multilevel-modulation symbol, the station device including: reception quality comparing means for comparing reception quality of the broadcast signal at a location of the mobile terminal device to predetermined reference quality; and hierarchical modulation setup means for specifying a difference in error rate in bit determination between the multiple different bits on the basis of a result of the comparison by the reception quality comparing means.
